(19) United States
(12) Patent Application Publication
(10) Pub. No.: US 2008/0025232 A1
(43) Pub. Date: Jan. 31, 2008

(54) METHOD AND SYSTEM FOR NETWORK CONNECTION

(75) Inventors: Christopher J. Martinez, Lake Worth, FL (US); Andrew D. Record, Durham, NC (US); Robert S. Sielken, Chapel Hill, NC (US)

Correspondence Address: CANTOR COLBURN LLP - IBM RSW, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/460,037

(22) Filed: Jul. 26, 2006

(51) Int. Cl. H04L 12/28

(52) U.S. Cl. 370/254

(57) ABSTRACT

A method to optimize a network connection on a network is disclosed. The method includes opening a socket listener on a device to listen for connections and initiating a first connection from the device to a server through the network. Sending a first message from the device via the first connection instructing the server to attempt to establish a second connection through the network to the socket listener, and determining the network status based upon the success of the second connection. In response to a successful attempt to establish the second connection, closing the first and second connection and maintaining the open socket listener. Following a failed attempt to establish the second connection, sending a second message from the server via the first connection, and closing the socket listener and keeping the first connection open between the device and the server.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to data networks, and particularly to detection of network configuration.

2. Description of Background

In the mobile device space, a mobile device frequently needs to communicate with a server machine using Transmission Control Protocol (TCP) connections. Often, the device opens a connection to the server to initiate communication. However, there are cases in which it is desired that the server opens the connection to the device to initiate communication. One example is for the server to provide updated information to the device without the device needing to request the connection or the information update. Such cases are complicated by the fact that the network between the device and the server may be Network Address Translated (NATed) or have a firewall that restricts communication. When a NAT or firewall is in place, the server may not be able to initiate contact with the mobile device via a TCP socket listener that runs on the mobile device waiting for TCP connection requests from the server.

Previous approaches have worked around this problem by simply having the device always initiate the connection to the server. An alternative approach has been to have both sides keep the connection active for communication in either direction. However, doing this causes the socket to be tied up for use on both the mobile device and the server, regardless of how much data (possibly none) is actually being transferred. This results in excessive use of network bandwidth, resource reuse, and power consumption. If a NAT or firewall is not blocking communication, the server can directly connect to the device and no constant TCP connection must be maintained. Handling both of these situations has been difficult with previous approaches. Accordingly, the state of the art will be advanced by a network optimization method that overcomes these drawbacks.

### SUMMARY OF THE INVENTION

The shortcomings of the prior art are overcome and additional advantages are provided through the provision of a method to optimize a network connection based upon the status of the network connection.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that will determine the status of a network connection. The solution will maintain an open connection if necessary for communication to be initiated by either of a server and a mobile device, and close the connection if communication may be initiated by either of the server and the device otherwise, thereby eliminating a needlessly open connection. This will optimize network communications to save network bandwidth, resource reuse, and power consumption.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a network communication system in accordance with an embodiment of the invention.

FIG. 2 illustrates one example of a flow chart for a method to practice an embodiment of the invention.

The detailed description explains the preferred embodiments of the invention, together with advantages and features, by way of example with reference to the drawings.

### DETAILED DESCRIPTION OF THE INVENTION

An embodiment of this invention will reduce the amount of constant TCP connections that must be maintained to support sending information to the device. An embodiment of the invention will dynamically detect whether or not a NAT or firewall has created a difficulty in establishing a connection with the device, and use the best TCP connection strategy based on that dynamic detection. This provides support for TCP connection in all environments, maximizes the resource utilization, and minimizes the number of sockets committed to constant connections.

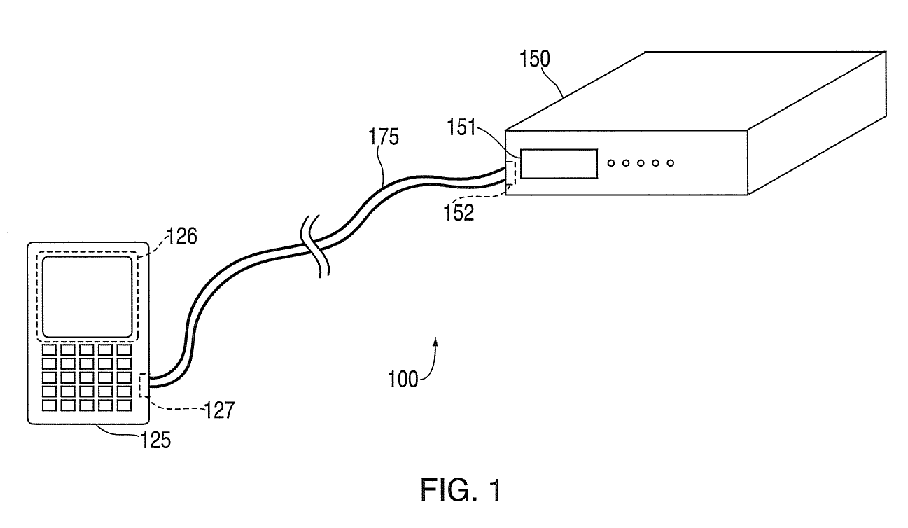

Referring now to FIG. 1, an exemplary embodiment of a network communication system 100 is depicted. The network system comprises a device 125, a server 150 configured to store and distribute data, and a network 175 configured to provide data communication between the device 125 and the server 150. In an embodiment the device 125 is a mobile device, configured to be portable, and carried by one hand of a user, such as a personal digital assistant (PDA), smartphone, and any other portable data processing device, for example. However, the scope of the invention is not limited to device 125 being a mobile device. For example, in an embodiment, device 125 may be a stationary desktop device. In an embodiment, the network 175 comprises a TCP network 175. However, the scope of the invention is not limited to the network 175 being the TCP network. The device 125 and the server 150 each comprise a program storage device 126, 151, readable by the device 125 and the server 150, respectively. The device 125 and the server 150 each further comprise a socket listener 127, 152 configured to listen for and respond to externally initiated requests for communication.

While an embodiment of the invention has been shown having a single network 175 connected to the server 150 via a wire, it will be appreciated that the scope of the invention is not so limited, and that the invention will also apply to other methods of transmitting data, such as a radio frequency or infra-red wireless network, for example, and that the server may be in data communication with additional devices, such as servers, workstations, and mobile devices, through additional networks, for example.

In an embodiment, the device 125 is configured to determine a connection status of the network 175. In an embodiment, the server 150 is configured to open the socket listener 152 and to listen for connections initiated from the device 125. In an embodiment, the device 125 is configured to open the socket listener 127 and also initiate a first connection through the network 175 to the socket listener 152 of the server 150, the first connection configured to instruct the server 150 to attempt to establish a second connection through the network 175 to the socket listener 127 of the device 125.

In response to a successful attempt to establish the second connection, the device 125 is configured to close the first and second connection, and to keep the socket listener 127 open, the socket listener 127 awaiting subsequent external requests for communication. In an embodiment, verification of the successful attempt to initiate the second connection originating from the server 150 will eliminate the need to keep a constant connection active in order for the device 125 to receive data from the server 150 in the absence of a request from the device 125. Accordingly the first and second connections are closed.

In an embodiment, in response to a failed attempt to establish the second connection, the server 150 is configured to send a second message to the device 125 via the first connection. In response to receiving the second message from the server 150, the device 125 is configured to keep the first connection open and close the socket listener 127. In an embodiment, keeping the first connection open, in response to the failure of the attempt to establish the second connection originating from the server 150, will enable the server 150 to send data to the device 125 at will, or, in the absence of a request from the device 125.

Difficulties associated with the attempt to establish the connection initiated by the server 150 through the network 175 to the device 125 are often related to the effects of a firewall or a NAT on the network 175. In an embodiment, the device 125 is configured to determine the effects of at least one of a firewall and a network address translation between the device 125 and the server 150.

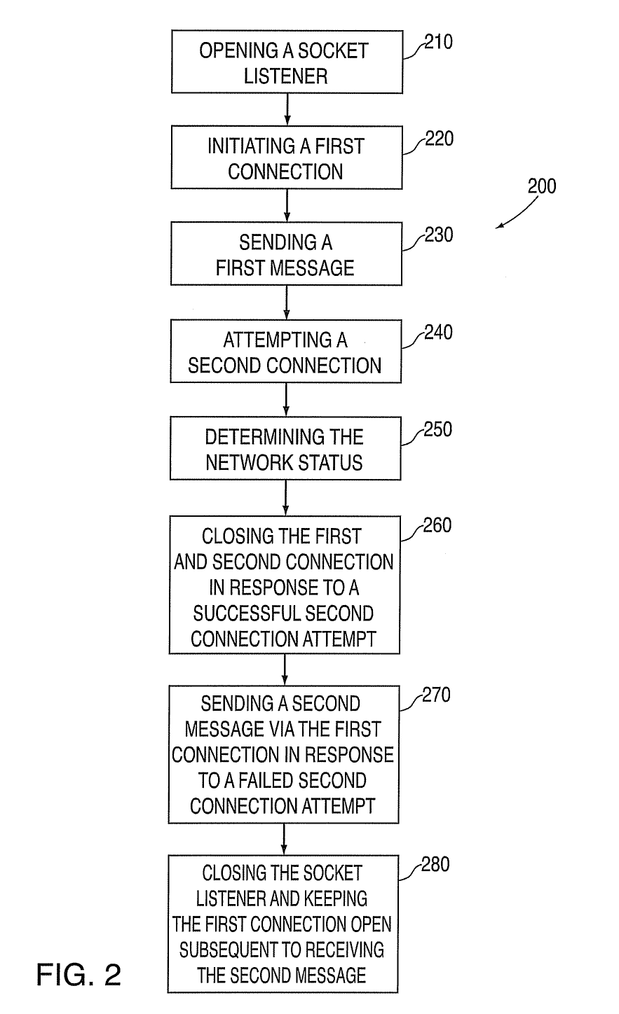

In view of the foregoing, the network communication system 100 performs the method of optimizing the network connection between the device 125 and the server 150. Referring now to FIG. 2, a flowchart 200 depicts the method.

The method begins with opening 210 the socket listener 127 on the device 125 to listen for connections, and initiating 220 the first connection from the device 125 to the server 150 through the network 175. Following the initiation 220 of the first connection, the method proceeds with sending 230 a first message from the device 125 via the first connection, the first message instructing the server 150 to attempt to establish the second connection through the network 175 to the socket listener 127 of the device 125. In an embodiment, the method further comprises opening the socket listener 152 on the server 150 to listen for connections from the device 125.

In an embodiment, the device 125 is a mobile device. In an embodiment, subsequent to sending 230 the first message, the server 150 continues by attempting 240 to establish the second connection from the server 150 to the socket listener 127 of the device 125. The method proceeds with the device 125 determining 250 the network status based upon the success of the attempt to establish the second connection.

In an embodiment, in response to a successful attempt to establish the second connection, the method proceeds with closing 260 the first and second connection and maintaining the open socket listener 127 to monitor for subsequent requests originating from the server 150 to establish a connection, without the need to maintain a constant, active connection between the device 125 and the server 150.

In an embodiment, in response to a failed attempt to establish the second connection, the method continues by sending 270 the second message from the server 150 to the device 125 via the first connection, and subsequent to the device 125 receiving the second message, closing 280 the socket listener 127 and keeping the first connection open between the device 125 and the server 150. There is no reason to keep the socket listener 127 open, as the failure to establish the second connection has demonstrated that the difficulty present within the network 175 will prevent any requests originating from the server 150 to establish a connection between the server 150 and the device 125. Accordingly, maintenance of the first active connection will allow the server 150 to subsequently send data to the device 125 at will, or, without the request from the device 125 to the server 150 for the data.

In an embodiment, the opening 210 a socket listener 127 comprises opening a TCP socket listener 127. In an embodiment, the determining 250 the network 175 status comprises determining 250 the effects of at least one firewall or network address translation between the device 125 and the server 150.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method to optimize a network connection on a network, the method comprising:
opening a socket listener on a device to listen for connections;
initiating a first connection from the device to a server through the network;
sending a first message from the device via the first connection, the first message instructing the server to attempt to establish a second connection through the network to the socket listener;
attempting to establish the second connection from the server to the socket listener;
determining the network status based upon the success of the second connection;
in response to a successful attempt to establish the second connection, closing the first and second connection and maintaining the open socket listener;
in response to a failed attempt to establish the second connection, sending a second message from the server via the first connection; and
subsequent to the device receiving the second message, closing the socket listener and keeping the first connection open between the device and the server.

2. The method of claim 1, wherein:
the opening the socket listener on the device comprises opening the socket listener on a mobile device.

3. The method of claim 1, wherein the opening the socket listener comprises:
opening a TCP socket listener.

4. The method of claim 1, wherein the determining the network status comprises:
determining the effects of at least one of a firewall and a network address translation between the device and the server.

5. The method of claim 1, further comprising:
opening a socket listener on the server to listen for connections from the device.

6. A network communication system comprising:
a network configured to provide data communication between a device and a server, the server configured to store and distribute data;
wherein the device is configured to determine a connection status of the network;
wherein the device is configured to open a socket listener and initiate a first connection through the network to the server, the first connection configured to instruct the server to attempt to establish a second connection through the network to the socket listener;
wherein in response to a successful attempt to establish the second connection, the device is configured to close the first and second connection, and to keep the socket listener open;
wherein in response to a failed attempt to establish the second connection, the server is configured to send a second message to the device via the first connection; and
wherein in response to receiving the second message from the server, the device is configured to keep the first connection open and close the socket listener.

7. The system of claim 6, wherein:
the device is configured to be portable and carried by one hand of a user.

8. The system of claim 6, wherein:
the network comprises a TCP network.

9. The system of claim 6, wherein:
the device is configured to determine the effects of at least one of a firewall and a network address translation between the device and the server.

10. The system of claim 6,
wherein the server is configured to open a socket listener and to listen for connections from the device.

11. A program storage device readable by a machine, the device embodying a program or instructions executable by the machine to perform the method of claim 1.
